(19) United States
(12) Patent Application Publication
(10) Pub. No.: US 2005/0214411 A1
(43) Pub. Date: Sep. 29, 2005

(54) Methods for suppressing acrylamide formation and restoring browned color and flavor

(76) Inventors: Robert Clarence Lindsay, Madison, WI (US); Sungjoon Jang, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 11/087,255

(22) Filed: Mar. 23, 2005

Related U.S. Application Data
(60) Provisional application No. 60/557,198, filed on Mar. 29, 2004.

(51) Int. Cl. A23L 1/28

(52) U.S. Cl. 426/62

(57) ABSTRACT

It is disclosed here that for any food preparation process that involves a high temperature heating step, the acrylamide level in the final food product can be reduced by treating an intermediate food material with a food-grade microorganism and/or a caramel coloring agent before the high temperature heating step. It is further disclosed that a food-grade microorganism and/or a caramel coloring agent can be used to restore diminished browned color and/or browned flavor in a food product in which the browned color and flavor are diminished as a result of other acrylamide reduction treatments.

### CROSS-REFERENCE TO RELATED APPLICATIONS

This application claims the benefit of U.S. provisional application 60/557,198, filed on Mar. 29, 2004, which is incorporated by reference in its entirety.

### STATEMENT REGARDING FEDERALLY SPONSORED RESEARCH OR DEVELOPMENT

Not applicable.

### BACKGROUND OF THE INVENTION

The formation of acrylamide, a neurotoxin suspected to be a carcinogen in humans, has been noted in certain cooked foods after uncooked foods are heated to high temperatures (at or above about 100° C.). Various formation mechanisms may be at work. It has been reported that asparagine in the foods, as well as other amino acids, can react with sugars via the Maillard reaction. While the Maillard reaction adds taste, aroma, and color to the cooked foods, it also yields acrylamide. As the major acrylamide formation pathway in food materials and products, a reducing sugar such as glucose and asparagine undergo carbonyl-amine condensation and the resultant condensation product dehydrates to form N-glucosylasparagine (FIG. 1). N-glucosylasparagine then undergoes decarboxylation and various other steps to generate acrylamide (FIG. 1).

The foods most susceptible to acrylamide formation during high temperature processing or cooking are foods that contain high levels of sugar/reducing sugar, high levels of starch (a source of glucose), high levels of free asparagine or a combination of any of the foregoing. These foods include, but are not limited to, potatoes, sweet potatoes, grains, asparagus, onions, bananas, nuts (e.g., almond nuts) and food products made from these foods. Large-scale processing methods for these foods and food products are known and typically include peeling the raw food matter, cutting the peeled matter into pieces of suitable sizes, optionally blanching the pieces in hot water and then cooling in cold water (fluming).

Vegetables and fruits are routinely blanched at 80° C. to 100° C. for the purpose of exhausting gasses from the tissues, thermally inactivating enzymes that cause off-flavors or off-colors, and thermally inactivating some vegetative cells of microorganisms. Blanching of potatoes is practiced mainly to thermally inactivate polyphenoloxidase for whitening potato tissue by preventing the formation of enzymatic blackening pigments. Such blanching is commonly accomplished at temperatures of 80° C. to 82° C. with hold times of 2 to 4 minutes. Lower blanching temperatures (i.e., below 80° C.) are avoided because of incomplete inactivation of polyphenoloxidase. It is also common to flume (transport, cool, and soak) blanched French fry strips in aqueous solutions at ambient temperatures for a few minutes up to one hour. A sugar is typically included in the fluming solution in order to provide the best color on potato pieces upon frying. Additionally, the pieces can be partially fried (“par-fried”) and/or frozen before being prepared for consumption by frying or baking. The general processes for potato processing are described in Potato Processing, Talburt, Van Nostrand, New York, 4^{th} Ed., W. F. and O. Smith, eds. (1987), incorporated by reference herein as if set forth in its entirety. Additional general processes for processing potatoes and other food materials are known to the skilled artisan.

In a related U.S. patent application published as U.S. 2004/0224066 (incorporated herein by reference in its entirety), the inventors disclosed several methods for reducing acrylamide formation in heated food materials. More methods for suppressing acrylamide formation in heated food materials are desirable.

Because acrylamide formation via a carbonyl-amino browning reaction between reducing sugars and asparagine is intricately interwoven with the overall Maillard browning reaction process in heated foods, successful suppression of acrylamide formation is often accompanied to some degree by diminished browned colors as well as browned flavors. Any known reintroductions of free browning chemicals per se (e.g., amino acids and free reducing sugars) in sufficient amounts to restore browned colors and flavors immediately override the acrylamide suppression caused by initial treatment. The art is desirous of methods for restoring browned color and flavor in food products without causing a substantial increase in the suppressed acrylamide level.

### BRIEF SUMMARY OF THE INVENTION

In one aspect, the present invention relates to a method for preparing a food material for high temperature processing in order to reduce acrylamide formation during a subsequent high temperature processing step. The method involves exposing the food material to a food-grade microorganism, a caramel coloring agent, or both in an amount effective to reduce acrylamide formation in a subsequent high temperature processing step. The food material treated as above is also within the scope of the present invention.

In another aspect, the present invention relates to a method for making a food product from a food material. The method involves exposing the food material to a food-grade microorganism, a caramel coloring agent, or both in an amount effective to reduce acrylamide formation in a subsequent high temperature processing step and heating the food material at a high temperature. The food product made as above is also within the scope of the present invention.

In another aspect, the present invention relates to a method for preparing a food material for high temperature processing following an acrylamide reduction treatment. The method involves exposing the food material to a food-grade microorganism, a caramel coloring agent, or both in an amount sufficient to provide more browned color, more browned flavor, or both upon high temperature heating in comparison to non-exposed control food materials. The food material treated as above is also within the scope of the present invention.

In another aspect, the present invention relates to a method for making a food product from a food material that has been treated for reducing acrylamide formation at high temperature processing. The method involves exposing the food material to a food-grade microorganism, a caramel coloring agent, or both in an amount sufficient to provide more browned color, more browned flavor, or both upon high temperature heating in comparison to non-exposed control food materials and heating the food material at a high temperature. The food product made as above is also within the scope of the present invention.

### BRIEF DESCRIPTION OF THE SEVERAL VIEWS OF THE DRAWINGS

FIG. 1 shows a major acrylamide formation pathway in food materials.

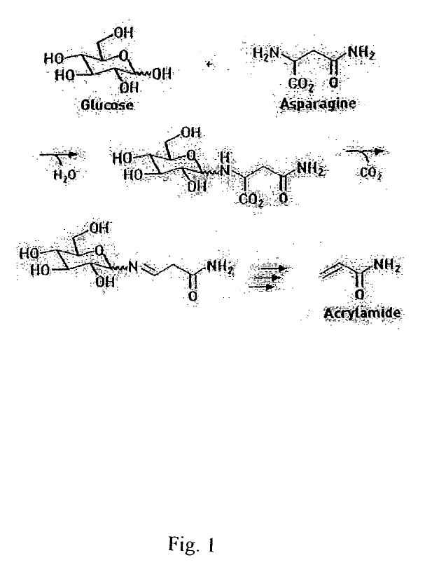

### DETAILED DESCRIPTION OF THE INVENTION

It is disclosed here that for any food preparation process that involves a high temperature heating step, the acrylamide level in the final food product can be reduced by treating an intermediate food material with a food-grade microorganism disclosed herein and/or a caramel coloring agent before the high temperature heating step. Preferably, the acrylamide suppressing methods disclosed herein reduce the acrylamide level in a final food product by at least 20%, 30%, 40%, 50%, 60%, 70%, 80%, 90% or 95%. It is further disclosed that a food-grade microorganism disclosed herein and/or a caramel coloring agent can also be used to restore diminished browned color and/or browned flavor in a food product in which the browned color and flavor are diminished as a result of other acrylamide reduction treatments. Since yeast and other microorganisms have been employed in certain food materials (e.g., yeast leavened breads and such other bakery goods) for various other purposes, with respect to using microorganisms to reduce acrylamide formation and to restore browned color and/or flavor, the present invention is directed at food materials that are not traditionally treated with a food-grade microorganism disclosed herein (e.g., fabricated potato chips, various corn chips, canned pureed sweet potatoes). Examples of using yeast and various caramel coloring agents to reduce acrylamide formation and to restore browned color and flavor are provided in Examples 1-5 below.

By high temperature heating, we mean exposing the food material to a temperature of at least 100° C., 120° C., 150° C., 180° C. or 190° C. Examples of high temperature heating in a food preparation process include but are not limited to frying, baking, roasting, steaming, boiling and high temperature extrusion. The present invention can be practiced with any food material (including animal food material) the heating of which at a high temperature can lead to the formation of acrylamide. Examples of such food materials include but are not limited to those that contain starch, high levels of free asparagine or both. A food material that contains starch is referred to as starchy-food material and the food products prepared therefrom are referred to as starchy-food. Examples of starchy-food include but are not limited to those prepared from potato or potato-based materials, sweet potato or sweet potato-based materials, grain (e.g., wheat, oat, rye, corn and rice) or grain-based materials, and meat products that contain starch (e.g., hamburger and fried chicken). Representative food products that are made of potatoes include French fries and potato chips. In addition, potatoes, sweet potatoes, grains and the like are often processed into doughs, batters and mash. From these doughs, batters and mash, products such as crackers, breads, quick-breads, cookies, chips, breakfast cereals and the like can be produced, as can deep-fried foods and extruded foods, such as snack foods.

The microorganisms that can be used to practice the present invention include yeasts, bacteria, and fungi. Examples of yeasts that can be used include but are not limited to Torula sp., Klyveromyces sp., Saccharomyces cervesiae (e.g. baker's/brewer's-type), and other sp. Examples of bacteria that can be used include but are not limited to lactic bacteria, Brevibacterium sp., Lactobacillus sp, Lactococcus sp., Leuconostoc sp, Bacillus sp., Pseudomonas sp., and Pediococcus sp. Examples of fungi that can be used include but are not limited to Penicillium sp., Aspergillus oryzae and other Aspergillus sp., Mucor sp., and Rhizopus sp. It is noted that natural and genetically engineered derivatives of a suitable microorganism described above can also be used in the present invention.

Yeast and other microorganisms are believed to suppress the formation of acrylamide in various high temperature heated foods by two mechanisms. First, the live yeasts and other microorganisms assimilate the free sugars (especially glucose, fructose, and sucrose) that react with asparagine to produce acrylamide under elevated temperature conditions. Secondly, yeast and other microorganisms may also assimilate (metabolize) free asparagine, thus removing a key precursor in the formation of acrylamide. Additionally, yeast and other microorganisms may possess the specific enzyme, asparaginase, which would simply de-amidate asparagine to yield aspartic acid and ammonia, again removing a key precursor for acrylamide formation.

Living yeast cells and cells of other microorganisms provide compartmentalized carbonyl compounds (especially cell sugars) and amino acids, and when heated to the high temperatures encountered in frying and baking, the sugars and amino acids react via a browning reaction to produce browned flavors and brown pigments. The uniqueness of the microbial cellular system in this application lies in the compartmentalization of reactants in the intact cells. This situation prevents the reactants from penetrating food material such as potato cell surface and initiating browning in the food material tissue which invariably leads to the reinstatement of elevated acrylamide levels in the food material. Trials with the addition of other browning-induction chemicals to acrylamide-reduced potato products before cooking always have been found to cause substantial acrylamide formation.

Caramel coloring agents are amorphous, brown to brownish materials resulting from the carefully controlled heat treatment of food grade carbohydrates. Food grade acids, alkalis, and salts may be employed to assist caramelization. Caramel coloring agents have been used to provide a wide range of familiar and pleasantly appearing colors in foods such as carbonated soft drinks and beverages, microwaveable entrees, pudding products, and baked goods, ranging from light yellows through reddish-browns to dark browns. Caramel coloring agents are exceptionally stable and can tolerate a wide range of physical and chemical environments found in food. For example, caramel coloring agents have good functionality across a wide range of pH from 2 to 10. Caramel coloring agents are typically provided as aqueous solutions having a highly acidic pH of about 3. There currently are two major suppliers of caramel coloring agents in the U.S. food industry, Sethness and D. D. Williamson.

Each caramel molecule carries an electrical charge formed during processing and caramel coloring agents carry either a positive or negative in ionic charge, depending in part on processing conditions. The International Technical Caramel Association has classified four caramel coloring agents based on the catalysts (if any) used in the reaction. Class I caramel coloring agents are caramels in which no catalysts are used. Class I caramels have a slightly negative charge. Class II caramel coloring agents are produced in sulfite catalyzed reactions, also have a negative charge. Class III caramel coloring agents are produced in ammonia catalyzed reactions and have a positive charge. Class IV caramel coloring agents are produced in an ammonia and sulfite catalyzed reaction and have a negative charge.

In the methods of the present invention, caramels are believed to reduce acrylamide formation by interacting with reducing sugars. Positively-charged caramels (amino group-containing polymers) are believed to be able to react with free reducing sugars (e.g., glucose), thereby scavenging them from the reaction medium and preventing their reaction with asparagine. Negatively-charged caramels (i.e., those with ionizable sulfite groups) are believed to be able to form an adduct with reducing sugars through the sulfite-groups on the caramel polymers and the free carbonyl groups on the reducing sugars.

All caramel coloring agents can be used in the methods of the present invention. In a preferred embodiment, caramel coloring agents employed are dark brown liquid or solid materials produced by controlled heat treatment of one or more of the following food-grade carbohydrates: dextrose, invert sugar, lactose, malt sirup, molasses, starch hydrolysates and fractions thereof, and sucrose. One or more of the following food-grade acids, alkalis, and salts can optionally be used to assist caramelization: (i) acids—acetic acid, citric acid, phosphoric acid, sulfuric acid, and sulfurous acid; (ii) alkalis—ammonium hydroxide, calcium hydroxide U.S.P., potassium hydroxide, and sodium hydroxide; and (iii) salts—ammonium, sodium, potassium carbonate, bicarbonate, phosphate (including dibasic phosphate and monobasic phosphate), sulfate, and sulfite. Polyglycerol esters of fatty acids can optionally be used as antifoaming agents in amounts not greater than that required to produce the intended effect. Preferably, the caramel coloring agents contain no more than 10 parts per million lead (Pb), no more than 3 parts per million arsenic (As), and no more than 0.1 part per million mercury (Hg).

In one aspect, the present invention relates to a method for preparing a food material for a high temperature heating step in order to reduce acrylamide formation while being processed at high temperatures. The method involves exposing the food material to a food-grade microorganism disclosed herein and/or a caramel coloring agent prior to subjecting the food material to the high temperature heating step. The microorganism and caramel coloring agent employed should be in an amount sufficient to suppress acrylamide formation so that the food material or product obtained after high temperature heating contains less acrylamide than a control food material or product that was not exposed to the microorganism and/or caramel coloring agent. Yeasts and other microorganisms will work particularly well with particulated food materials in which the cellular and tissue structures are dismantled so that the sugars and asparagine are released and thus accessible to the microorganisms. For caramel coloring agents that can enter into cells, they will work effectively with both particulated food materials and food materials with essentially intact cellular and tissue structures. The food materials treated according to the method are also within the scope of the present invention.

In another aspect, the present invention relates to a method of making a food product from a food material. The method involves exposing the food material to a food-grade microorganism disclosed herein and/or a caramel coloring agent as described above, and heating the food material at a high temperature. The food product made by the method such as French fries and potato chips are within the scope of the present invention.

In still another aspect, the present invention relates to a method for preparing a food material for high temperature processing wherein the food material has already been treated (e.g., by a method disclosed in U.S. patent application publication No. 2004/0224066) for the purpose of reducing acrylamide formation during high temperature processing and wherein the above acrylamide reduction treatment will lead to diminished browned color, browned flavor or both in the final food product. The method involves exposing the food material that has already been treated for acrylamide reduction to a food-grade microorganism disclosed herein and/or a caramel coloring agent in an amount sufficient to provide more browned color, more browned flavor or both upon high temperature heating in comparison to non-exposed control food materials. As a result, the diminished browned color, browned flavor or both caused by the acrylamide reduction treatment is at least partially restored in the final food product. The method has the advantage of not significantly increasing the acrylamide level suppressed by the acrylamide reduction treatment. The food material treated by the method is also within the scope of the present invention.

In yet another aspect, the present invention relates to a method of making a food product from a food material that has been subject to acrylamide reduction treatment wherein at least some of the browned color and flavor diminished in the final food product as a result of the acrylamide reduction treatment is restored. The method involves exposing the food material to a food-grade microorganism disclosed herein and/or a caramel coloring agent and heating the food material at a high temperature. The microorganism and caramel coloring agent employed should be in an amount sufficient to provide more browned color, more browned flavor or both upon high temperature heating in comparison to non-exposed control food materials. The food product made by the method such as French fries and potato chips are within the scope of the present invention.

In one embodiment, the methods of the present invention are practiced in connection with food materials in which the cellular and tissue structures are dismantled. Examples of such food materials include potato-, sweet potato- and grain-based doughs, batters and mash for making particulate food products. General compositional information and fabrication technology methods involving doughs and batters are described in Fabricated Foods, Avi Publishing Co., Inglett, G. E., ed. (1975), incorporated by reference as if set forth herein in its entirety. In this embodiment, a food-grade microorganism and/or a caramel coloring agent can be added and mixed with the food material in the form of a solid. Alternatively, the microorganism and/or the caramel coloring agent can be provided in a concentrated liquid suspension, emulsion or solution and mixed with the food material. For any particular application of the invention, the full range of the effective amounts of a microorganism and/or a caramel coloring agent and the full range of the effective treatment times as well as other treatment conditions can be readily determined by a skilled artisan through routine experimentation.

As a specific example for using yeasts to reduce acrylamide formation, about 0.25% to about 10.0% aqueous active or metabolizing yeast (dry wt basis) can be added to a food material with water at the time of mixing. Then the wetted ingredients are held for about 0.5 minutes to about 12 hours, preferably for about 60 minutes, at a preferred temperature in the range of about 10 to about 50° C., of about 5° to about 45° C., of about 10° to about 40° C., or of about 15° to about 35° C. (e.g., at about 30° C.) before finishing preparation, such as frying or baking. Typical reductions in acrylamide formation of 20 to 95% can be achieved by suitable treatments compared to untreated controls.

In another embodiment, the methods of the present invention are practiced in connection with food materials having essentially intact cellular and tissue structures. Examples of such food materials include but are not limited to cut or sliced potatoes for making French fries and potato chips, cut or sliced sweet potatoes for making fried sweet potato products, various raw nuts (e.g., almond nuts) for making roasted nuts, and various cut vegetables. In this embodiment, the microorganism and/or the caramel coloring agent is provided in a liquid suspension, emulsion or solution to treat the food material. For any particular application of the invention, the full range of the effective amounts of an microorganism and/or a caramel coloring agent and the full range of the effective treatment times as well as other treatment conditions can be readily determined by a skilled artisan through routine experimentation.

As a specific example for using yeasts to restore browned color, browned flavor or both, intermediately processed foods (e.g., blanched potato strips and slices, and sweet potato slices) are dipped (submerged), before frying or baking, in an aqueous metabolizing yeast dispersion having about 1% to about 25% (total wt basis), preferably about 5%, metabolizing yeast, for a period in the range of about 1 second to about 60 minutes at a temperature in the range of about 10 to about 50° C., of about 5° to about 45° C., of about 10° to about 40° C., or of about 15° to about 35° C. (e.g. at about 30°), preferably for a period of about 10 seconds at about 21° C. The dipped food pieces are then fried, or heated at a high temperature by other suitable means, to yield finished products with enhanced colors and flavors to accompany a reduced acrylamide concentration. For potato chips, the sliced potatoes can be dipped into the aqueous yeast dispersion right before frying. For French fries, the par-fried potato strips can be dipped into the aqueous yeast dispersion and then be frozen for storage and transportation. The frozen strips can then be conventionally processed (e.g., fried) to make French fries.

While several theories on how the microorganisms and caramel coloring agents work in the context of the present invention are described above, the present invention is not intended to be limited by these theories.

The following examples are given to further illustrate the present invention. The present invention is not limited to the specific details set forth in the examples.

### EXAMPLE 1

### Yeast Application Reduced Acrylamide Level in Deep Fried Potato Flake Nuggets

This example illustrates the utility of yeast for reducing acrylamide in potato flour/flake-based foods such as fabricated potato chips and frozen potato nuggets.

Procedure for making potato flake nuggets: The nuggets were prepared with commercial dehydrated potato flakes and active commercial baker's yeast. Potato nuggets were prepared from basic combinations of 50 g potato flakes+100 g deionized water that were first mixed into a dough. For treated samples, baker's yeast of appropriate amounts (0.25%-10% wt basis) were then added, and variously incubated (5°-45° C., preferably 30° C. for 0.5 min to 12 hr) to permit yeast metabolism to impact on glucose and asparagine in the dough. Then, the dough was extruded at ambient temperature using hand-held chef's piping bag equipped with a plastic 10 mm i.d. plastic tip (Hutzler Manufacturing Co., Canaan, Conn.) into potato nuggets (solid rods, 10 mm diameter×30 mm length). Finally, the nuggets were fried at about 180° C. (355° F.) in food service partially hydrogenated vegetable oil for 1 min. Finished nuggets were evaluated for physical characteristics, and then were analyzed for acrylamide using GC-MS techniques.

Results: Results showing the reduction of acrylamide by yeasts in potato nuggets are presented in Table 1 and Table 2. The data show that with appropriate incubation, 1% yeast inoculations resulted in about 50-70% reductions in acrylamide in yeast-treated samples compared to untreated control samples of potato flake nuggets.

TABLE 1
Evaluation of Various Processing Conditions and Ingredients for the
Reduction of Acrylamide Formation in Deep-Fried
Potato Flake Extruded Nuggets.

| | | Reduction |
|---|---|---|
| Potato Nugget | Acrylamide Concentration | (% versus |
| Sample^{a} Treatment | (μg/kg; ppb) | Untreated) |
| Background - Base not | 16 | — |
| fried potato nuggets^{b} | | |
| (wet wt basis) | | |
| Untreated: | | |
| Base + 1% yeast (total wet | 1456 | — |
| wt basis) | (1456 − 16 = 1440) | (—) |
| not held, fried | | |
| Treated: | | |
| Base + 1% yeast (total wet | 466 | 68 |
| wt basis) | (466 − 16 = 450) | (69) |
| held 1 h at 30° C., | | |
| fried | | |
| Treated: | | |
| Base + 1% yeast (total wet | 719 | 50 |
| wt basis) | (719 − 16 = 703) | (51) |
| held 24 h at 30° C., | | |
| fried | | |
| ^{a}Prepared with commercial dehydrated potato flakes and active commercial baker's yeast. | | |
| ^{b}Potato nuggets (solid rods, 10 mm diameter × 30 mm length) were prepared from basic combinations of 50 g potato flakes + 100 g deionized water that were mixed, then extruded at ambient temperature using hand-held chef's piping bag equipped with a plastic 10 mm i.d. plastic tip (Hutzler Manufacturing Co., | | |
| # Canaan, CT). When cooked, nuggets were fried at about 180° C. (355° F.) in food service partially hydrogenated vegetable oil for 1 min. | | |

TABLE 2
Evaluation of Various Processing Conditions and Ingredients for the
Reduction of Acrylamide Formation in Deep-Fried Potato Flake
Extruded Nuggets.

| | | Reduction |
|---|---|---|
| Potato Nugget | Acrylamide Concentration | (% versus |
| Sample^{a} Treatment | (μg/kg; ppb) | Untreated) |
| Background - Base not | 16 | — |
| fried potato nuggets^{b} | | |
| (wet wt basis) | | |
| Base + 1% yeast (total wet | 409 | — |
| wt basis) | (409 − 16 = 393) | (—) |
| not held, fried | | |
| Base + 1% yeast (total wet | 152 | 63 |
| wt basis) | (152 − 16 = 136) | (65) |
| held 1 h at 30° C., | | |
| fried | | |
| Base + 1% yeast + 1% | 440 | — |
| pectic acid (total wet wt | (440 − 16 = 424) | (—) |
| basis) | | |
| not held, fried | | |
| Base + 1% yeast + 1% | 127 | 71 |
| pectic acid (total wet wt | (127 − 16 = 111) | (74) |
| basis) | | |
| held 1 h at 30° C., | | |
| fried | | |
| ^{a}Prepared with commercial dehydrated potato flakes. | | |
| ^{b}Potato nuggets (solid rods, 10 mm diameter × 30 mm length) were prepared from basic combinations of 50 g potato flakes + 100 g deionized water that were mixed, then extruded at ambient temperature using hand-held chef's piping bag equipped with a plastic 10 mm i.d. plastic tip (Hutzler Manufacturing Co., | | |
| # Canaan, CT). When cooked, nuggets were fried at about 180° C. (355° F.) in food service partially hydrogenated vegetable oil for 1 min. | | |

### EXAMPLE 2

### Yeast Application to Potato Chips for Restoring Browned Flavor and Brown Color

This example illustrates the use of the application of living yeasts to the surfaces of raw potato slices before frying to restore brown colors and browned flavors in fried, acrylamide-reduced potato chips.

Procedure for making fried potato chips: Potatoes (commercial chip potato variety) were peeled and cut into 1.5 mm thick chips with a Hobart slicer. The cut potatoes were blanched at 70° C. for 30 minutes in water (control) or indicated solutions. Next, the cut potatoes were rinsed at about 21° C. for 1 minute in water (control) or indicated solutions by immersing the cut potatoes in water or indicated solutions. Potato slices were then transiently dipped (15 sec to 1 min) in solutions of baker's yeasts (0.25%-10% wt basis) and drained, and the treated potato slices were fried in commercial partially hydrogenated vegetable oil at 180° C. for about 2 minutes or until steam bubbles ceased. Samples were evaluated for color and flavor, and also were analyzed for acrylamide using GC-MS.

Results: Potato chips prepared by dipping partially-processed potato slices into 10% yeast suspensions before frying showed very good restoration of a light brown color, and exhibited a very desirable fried, potato-like flavor. Earlier attempts to restore browned color and flavor by introducing pure and/or mixed reaction chemical compositions to potato slices resulted in elevation of acrylamide levels because of re-instituting the Maillard browning reaction. However, when cellular yeast was introduced to potato surfaces before frying, the browning reaction was confined to the cells and did not elevate the acrylamide concentration in the finished potato chips (Table 3).

TABLE 3
Evaluation of Various Processing Conditions and Ingredients for the
Reduction of Acrylamide Formation in Potato Chips.

| | Acrylamide | Reduction |
|---|---|---|
| Potato Chip | Concentration | (% versus |
| Sample^{a} Treatment | (μg/kg; ppb) | Untreated) |
| Untreated | 421 | — |
| cut, wash & fry^{b} | (from another | |
| | similar | |
| | experiment) | |
| + after washing, 1 min tempering at | 47 | Estimated |
| 70° C., then held at 70° C. in 1000 ppm | | 89 |
| CaCl₂ for 30 min; then rinsed with | | |
| ambient (21° C.) deionized water, and | | |
| finally held in 10% live Baker's yeast | | |
| solution (wt basis) at 30° C. for 10 min | | |
| before frying | | |
| + after washing, 1 min tempering at | 46 | Estimated |
| 70° C., then held at 70° C. in 1.5% NaCl for | | 89 |
| 30 min; then rinsed with ambient (21° C.) | | |
| deionized water, and finally held in 10% | | |
| live Baker's yeast solution (wt basis) at | | |
| 30° C. for 10 min before frying | | |
| + after washing, 1 min tempering at | 47 | Estimated |
| 70° C., then held at 70° C. in 1000 ppm | | 89 |
| CaCl₂ & 1.5% NaCl for 30 min; then | | |
| rinsed with ambient (21° C.) deionized | | |
| water, and finally held in 10% live | | |
| Baker's yeast solution (wt basis) at 30° C. | | |
| for 10 min before frying | | |

^{a}Prepared with a commercial potato chip variety.
^{b}Chips were cut 1.5 mm thick with Hobart slicer, and then washed (about 1 min) in excess (about 20:1) deionized water at ambient temperature (about 21° C.). After removing and draining, the chips were fried at about 180° C. (355° F.) in food service partially hydrogenated vegetable oil until steam bubbles ceased (about 2 min).

### EXAMPLE 3

### Sweet Potato Model for Application of Yeasts into Fresh Plant Purees (Potato, Sweet Potato, Asparagus, etc) for the Reduction of Acrylamide

Procedure for making sweet potato puree: Fresh retail, commercial sweet potatoes were first into 1 cm thick slices, and then were steam-cooked (e.g., about 100° C.) for 20 min. The slices (pieces) were then peeled. Then, aqueous suspensions of yeast (0.1% to 10% dry yeast wt basis) were added to sweet potato mash (100 g sweet potato mash+100 g aqueous suspension of yeasts). Final purees were made by manually pureeing (vigorously stirring) the mixtures.

Results: Data for autoclaved (simulated canned) sweet potato puree (Table 4) revealed that inoculation of the pre-autoclaved puree with 0.75% bakers yeast followed by incubation at 30° C. for 60 min resulted in a 72% reduction in acrylamide compared to a control without yeast.

TABLE 4
Evaluation of Various Processing Conditions and Ingredients for the
Reduction of Acrylamide Formation in Autoclaved Sweet Potato Puree.

| | | Reduction |
|---|---|---|
| Sweet Potato Puree | Acrylamide Concentration | (% verses |
| Sample^{a} Treatment | (μg/kg; ppb) | Untreated) |
| Untreated: | | |
| Slice 1 mm, 20 min in | 142 | — |
| steamer, peel, puree w/50 ml | | |
| added HOH, then add | | |
| 0.75% dry baker's yeast | | |
| (total wt basis), then | | |
| autoclave at 121° C. for 60 min | | |
| Treated: | | |
| Slice 1 mm, 20 min in | 40 | 72 |
| steamer, peel, puree w/50 ml | | |
| added HOH, then add | | |
| 0.75% dry baker's yeast | | |
| (total wt basis), incubate | | |
| 30° C. 60 min, then | | |
| autoclave at 121° C. for 60 min | | |

^{a}Prepared with a fresh, retail, commercial sweet potato variety.
^{b}Sweet potato puree series.

### EXAMPLE 4

### Yeast Application Reduced Acrylamide Level in Deep Fried Corn Strip Chips

This example illustrates the utility of yeast for reducing acrylamide in fried corn flour-based foods such as fabricated corn chips and taco shells.

Procedure for making corn flour nuggets: Corn flour nuggets were prepared with (raw) whole yellow corn meal (flour), sodium pectate, and active commercial baker's yeast. Corn strip chips (strips/ribbons, 40 mm long×35 mm wide×4 mm thick) were prepared from basic combinations of 50 g raw corn meal+75 g deionized water that were mixed to a dough, cooked at 80° C. for 30 min, treatments applied, and then extruded through a die at ambient temperature using hand-held chef's piping bag equipped with a suitable metal tip. Strip chips were fried at about 180° C. (355° F.) in food service partially hydrogenated vegetable oil for 2 min. Finished strip chips were evaluated for physical characteristics, and then were analyzed for acrylamide using GC-MS techniques.

Results: Representative data for the reduction of acrylamide in fried corn flour nuggets are shown in Table 5. In this case, the addition of 0.56% yeast along with incubation at 30° C. for 60 min to a precooked dough also containing 0.56% sodium pectate resulted in an 82% reduction of acrylamide compared to a control sample. Approximately 40% of the total reduction in acrylamide was attributed to the yeast metabolism (incubated sample) when compared to the not incubated (not held) sample. In this comparison, it can be deduced that about 40% of the total 82% reduction was attributable to the added sodium pectate.

TABLE 5
Evaluation of Various Processing Conditions and Ingredients for the
Reduction of Acrylamide Formation in Deep-Fried Strip Chips
Made from Precooked Extruded Yellow Corn Dough.

| | | Reduction |
|---|---|---|
| Corn Strip Chip | Acrylamide Concentration | (% versus |
| Sample^{a} Treatment | (μg/kg; ppb) | Untreated) |
| Untreated: | | |
| Control-Base 1 | 12 | — |
| dough not precooked | | |
| fried | | |
| Untreated: | | |
| Control Bas 2^{b} | 61 | — |
| dough precooked | | |
| fried | | |
| Treated: | | |
| Base 2 + 0.56% Na | 36 | 41 |
| pectate (total wet wt | | |
| basis + 30 g HOH) plus | | |
| 0.56% live yeast (total | | |
| wet wt basis + 20 g | | |
| HOH) | | |
| not held | | |
| fried | | |
| Treated: | | |
| Base 2 + 0.56% Na | 11 | 82 |
| pectate (total wet wt | | |
| basis + 30 g HOH) plus | | |
| 0.56% live yeast (total | | |
| wet wt basis + 20 g | | |
| HOH) | | |
| held 60 min at 30° C., | | |
| fried | | |
| ^{a}Prepared with (raw) yellow corn meal, sodium pectate, and active commercial baker's yeast. | | |
| ^{b}Control corn strip chips (strips/ribbons, 40 mm long × 35 mm wide × 4 mm thick) were prepared from basic combinations of 50 g raw corn meal + 75 g deionized water that were mixed to a dough, cooked at 80° C. for 30 min, treatments applied, and then extruded through a die at ambient temperature using | | |
| # hand-held chef's piping bag equipped with a suitable metal tip. Strip chips were fried at about 180° C. (355° F.) in food service partially hydrogenated vegetable oil for 2 min. | | |

### EXAMPLE 5

### Restoration of Browned Flavor and Brown Color in Potato Chip by Caramel Coloring Agents

Potato chips were made and color and flavor were analyzed similarly as described in Example 2 except that caramel coloring agents were used. Briefly, caramel color concentrates (Sethness Caramel Colors, Chicago, Ill.) were prepared into aqueous immersion solutions (0.05% wt/wt; range 0.01-0.5% wt/wt). Potatoes (chips, French fries) were variously prepared (as indicated in Table 6; objective: acrylamide suppression), and then as a final step were dipped (1 sec-120 sec) into a caramel immersion solution before frying.

The application of an appropriate amount of aqueous caramel coloring yielded excellent brown colors ranging from darker-browns to very light golden browns. When caramel coloring is combined with yeast in immersion solutions, both desirable golden brown colors and pleasant fried flavors result.

In addition to providing desirable golden brown colors without off-flavors into fried potato chips, the application of some caramel colorings did not induce the formation of acrylamide by reinstituting the Maillard browning reaction in treated fried potato products. This can be seen from the acrylamide data in potato chip samples prepared with various commercial caramel colorings (Sethness P212-NH3; Sethness RT 180-NH3+S02; and Sethness BC 145-S02) as presented in Table 6.

TABLE 6
Evaluation of Various Processing Conditions and Ingredients for the
Reduction of Acrylamide Formation in Potato Chips.

| | Acrylamide | Reduction |
|---|---|---|
| Potato Chip | Concentration | (% versus |
| Sample^{a} Treatment | (μg/kg; ppb) | Untreated) |
| Untreated | | |
| cut, wash & fry^{b} | 308 | — |
| “Treated”-Process Control | | |
| cut, wash + 70° C. | 43 | 86 |
| in 1000 ppm CaCl₂ plus | | |
| 1.5% NaCl in tapwater for 30 min + 15° C. | | |
| soak in tapwater for 1 min | | |
| fry^{b} | | |
| Treated | | |
| cut, wash + 70° C. | 57 | 81 |
| in 1000 ppm CaCl₂ plus | | |
| 1.5% NaCl in tapwater for 30 min + 15° C. | | |
| soak in tapwater for 1 min + dip | | |
| in 0.05% Sethness P212 all | | |
| NH₃ caramel | | |
| fry^{b} | | |
| Treated | | |
| cut, wash + 70° C. | 54 | 82 |
| in 1000 ppm CaCl₂ plus | | |
| 1.5% NaCl in tapwater for 30 min + 15° C. | | |
| soak in tapwater for 1 min + dip | | |
| in 0.05% Sethness RT180 | | |
| SO₃/NH₃ caramel | | |
| fry^{b} | | |
| Treated | | |
| cut, wash + 70° C. | 43 | 86 |
| in 1000 ppm CaCl₂ plus | | |
| 1.5% NaCl in tapwater for 30 min + 15° C. | | |
| soak in tapwater for 1 min + dip | | |
| in 0.05% Sethness BC 145 | | |
| all SO₃ caramel | | |
| fry^{b} | | |

^{a}Prepared with a commercial potato chip variety.
^{b}Chips were cut 1.5 mm thick with Hobart slicer, and then washed (about 1 min) in excess (about 20:1) deionized water at ambient temperature (about 21° C.). After removing and draining, the chips were fried at about 180° C. (355° F.) in food service partially hydrogenated vegetable oil until steam bubbles ceased (about 2 min).

The present invention is not intended to be limited to the foregoing examples, but to encompass all such modifications and variations as come within the scope of the appended claims.

1. A method for preparing a particulated food material not traditionally treated with microorganisms for high temperature processing in order to reduce acrylamide formation during the high temperature processing, the method comprising the step of:
exposing the food material to a food-grade microorganism in an amount effective to reduce acrylamide formation in a subsequent high temperature processing step.

2. The method of claim 1, wherein the microorganism is selected from the group consisting of yeasts, bacteria and fungi.

3. The method of claim 1, wherein the food material is exposed to the microorganism by adding an liquid suspension of the microorganism to the food material.

4. The method of claim 1, wherein the amount of the microorganism to which the food material is exposed is from about 0.25% to about 10% of the food material by weight.

5. The method of claim 1, wherein the food material is exposed to the microorganism for about 30 seconds to about 12 hours.

6. The method of claim 1, wherein the food material is exposed to the microorganism at a temperature from about 1° C. to about 50° C.

7. The method of claim 1, wherein the acrylamide formation during high temperature processing will be reduced by at least 20%.

8. The method of claim 1, wherein the food material is selected from the group consisting of potato-based dough, potato-based batter, potato-based mash, grain-based dough, grain-based batter, and grain-based mash.

9. A method for making a food product from a food material not traditionally treated with microorganisms, the method comprising the steps of:
exposing the food material to a food-grade microorganism in an amount effective to reduce acrylamide formation in a subsequent high temperature processing step; and
heating the food material at a high temperature.

10. A method for preparing a food material for high temperature processing following acrylamide reduction treatment, wherein the food material is one that is not traditionally treated with microorganisms, the method comprising the step of:
exposing the food material to a food-grade microorganism in an amount sufficient to provide more browned color, more browned flavor or both upon high temperature heating in comparison to non-exposed control food materials.

11. The method of claim 10, wherein the microorganism is selected from the group consisting of yeasts, bacteria and fungi.

12. The method of claim 10, wherein the food material is treated with a liquid suspension of the microorganism to coat the surface of the food material.

13. The method of claim 10, wherein the food material is selected from the group consisting of peeled and cut potatoes, and peeled and cut sweet potatoes.

14. The method of claim 13, wherein the food material is selected from the group consisting of potato slices for making potato chips and par-fired potato strips for making French fries.

15. A method for making a food product from a food material that has been treated for reducing acrylamide formation at high temperature processing, wherein the food material is not traditionally treated with microorganisms in making the food product, the method comprising the step of:
preparing the food material according to claim 10; and
heating the food material at a high temperature.

16. A food material that has been treated according to the method of claim 1.

17. A food material that has been treated according to the method of claim 10.

18. A food product made according to the method of claim 9.

19. A food product made according to the method of claim 15.

20. A method for preparing a food material for high temperature processing, the method comprising the step of:
exposing the food material to a caramel coloring agent in an amount effective to reduce acrylamide formation in a subsequent high temperature processing step.

21. A method for making a food product from a food material, the method comprising the step of:
preparing the food material according to claim 20; and
heating the food material at a high temperature.

22. A food material that has been treated according to the method of claim 20.

23. A food product made according to the method of claim 21.

24. A method for preparing a food material for high temperature processing wherein the food material has been treated for reducing acrylamide formation in the subsequent high temperature processing step, the method comprising the step of:
exposing the food material to a caramel coloring agent in an amount sufficient to provide more browned color, more browned flavor or both upon high temperature heating in comparison to non-exposed control food materials.

25. A method for making a food product from a food material that has been treated for reducing acrylamide formation in a subsequent high temperature processing step, the method comprising the step of:
preparing the food material according to claim 24; and
heating the food material at a high temperature.

26. A food material that has been treated according to the method of claim 24.

27. A food product made according to the method of claim 25.
